(19) United States
(12) Patent Application Publication
(10) Pub. No.: US 2024/0032040 A1
(43) Pub. Date: Jan. 25, 2024

(54) SIMULTANEOUS PHYSICAL UPLINK CONTROL CHANNEL TRANSMISSIONS OVER MULTI-PANEL

(71) Applicant: Apple Inc., Cupertino, CA (US)

(72) Inventors: Seyed Ali Akbar Fakoorian, San Diego, CA (US); Dawei Zhang, Saratoga, CA (US); Wei Zeng, Saratoga, CA (US); Weidong Yang, Cupertino, CA (US); Yushu Zhang, Beijing (CN); Hong He, San Jose, CA (US); Sigen Ye, San Diego, CA (US)

(73) Assignee: Apple Inc., Cupertino, CA (US)

(21) Appl. No.: 18/218,526

(22) Filed: Jul. 5, 2023

Related U.S. Application Data
(60) Provisional application No. 63/391,692, filed on Jul. 22, 2022.

(51) Int. Cl. H04W 72/21; H04L 5/00

(52) U.S. Cl. CPC H04W 72/21; H04L 5/0035

(57) ABSTRACT

Techniques are disclosed herein for single downlink control information based simultaneous physical uplink control channel transmission over multi-panel. An example embodiment can include a user equipment (UE) configured to receive a first indication as to a multi-panel simultaneous transmission scheme for simultaneous transmission of a physical uplink control channel (PUCCH) transmission in the frequency domain (FD) based on a radio resource control (RRC) transmission, the PUCCH transmission including a first PUCCH transmission through a first panel over a first FD part and a second PUCCH transmission through a second panel over a second FD part. The UE can transmit the first PUCCH transmission through first panel over the first FD part via the multi-panel simultaneous transmission scheme. The UE can further simultaneously transmit the second PUCCH transmission through the second panel over the second FD part via the multi-panel simultaneous transmission scheme.

### CROSS-REFERENCE TO RELATED APPLICATIONS

This application is claims the benefit of U.S. Provisional Application No. 63/391,692, filed on Jul. 22, 2022, which is incorporated by reference.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of a system for simultaneous physical uplink control channel (PUCCH) transmission, according to one or more embodiments.

FIG. 2 is an illustration of a simultaneous PUCCH transmission scheme, according to one or more embodiments.

FIG. 3 is a process flow for implementing a simultaneous transmission multi-panel (ST×MP) scheme, according to one or more embodiments.

FIG. 4 is a process flow for implementing an ST×MP scheme, according to one or more embodiments.

FIG. 5 is a process flow for implementing an ST×MP scheme, according to one or more embodiments.

FIG. 6 is an illustration of an ST×MP scheme with frequency division multiplexing, according to one or more embodiments.

FIG. 7 is an illustration of an ST×MP scheme, according to one or more embodiments.

FIG. 8 is a process flow for implementing an ST×MP scheme, according to one or more embodiments.

FIG. 9 is an illustration of an ST×MP scheme, according to one or more embodiments.

FIG. 10 is a process flow for implementing an ST×MP scheme, according to one or more embodiments.

FIG. 11 is a process flow for implementing an ST×MP scheme, according to one or more embodiments.

FIG. 12 is a process flow for implementing an ST×MP scheme, according to one or more embodiments.

FIG. 13 is a process flow for implementing an ST×MP scheme, according to one or more embodiments.

FIG. 14 is a process flow for implementing an ST×MP scheme, according to one or more embodiments.

FIG. 15 is an illustration of an ST×MP scheme, according to one or more embodiments.

FIG. 16 is a process flow for implementing an ST×MP scheme, according to one or more embodiments.

FIG. 17 is a process flow for implementing an ST×MP scheme, according to one or more embodiments.

FIG. 18 is a process flow for implementing an ST×MP scheme, according to one or more embodiments.

FIG. 19 illustrates an example of receive components, in accordance with some embodiments.

FIG. 20 illustrates an example of a UE, in accordance with some embodiments.

FIG. 21 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and

B).

A user equipment (UE) can send multiple repetitions of physical uplink control channel (PUNCH) transmission across different uplink (UL) beams to different transmission and reception points (TRP) of one or more base stations. For these PUCCH transmissions, one method is that the repetitions are transmitted over a common signal path using time-division multiplexing (TDM). In other words, the PUCCH transmissions are one after the other rather than simultaneously.

A simultaneous PUCCH transmission repetition scheme in the frequency domain can lead to higher reliability and lower latency than the consecutive schemes. One issue for implementing simultaneous PUCCH transmission over multi-panels is determining a procedure for a UE and base station to follow. In this regard, the procedure should account for resource allocation and UCI bit mapping, demodulation reference signal (DMRS) mapping, and PUCCH transmission beam mapping. Another issue is that a UCI multiplexing procedure should account for overlapping PUCCH transmissions, where at least one of the PUCCH transmissions is a simultaneous multi-panel transmission. The UCI multiplexing procedure should also account for overlapping of a PUCCH transmission and a physical uplink shared channel (PUSCH) transmission, where the PUCCH transmission is a simultaneous multi-panel transmission.

Embodiments described herein address the above issues by providing a methodology for a single-DCI (s-DCI) simultaneous PUCCH transmissions through multiple UE antenna panels. The base station can configure the UE to engage in one of the simultaneous PUCCH transmission schemes that the UE can support. The UE can then simultaneously transmit the first PUCCH transmission using a first panel and the second PUCCH transmission using a second panel.

Embodiments of the present disclosure are described in connection with 5G networks. However, the embodiments are not limited as such and similarly apply to other types of communication networks, including other types of cellular networks, such as an LTE network.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

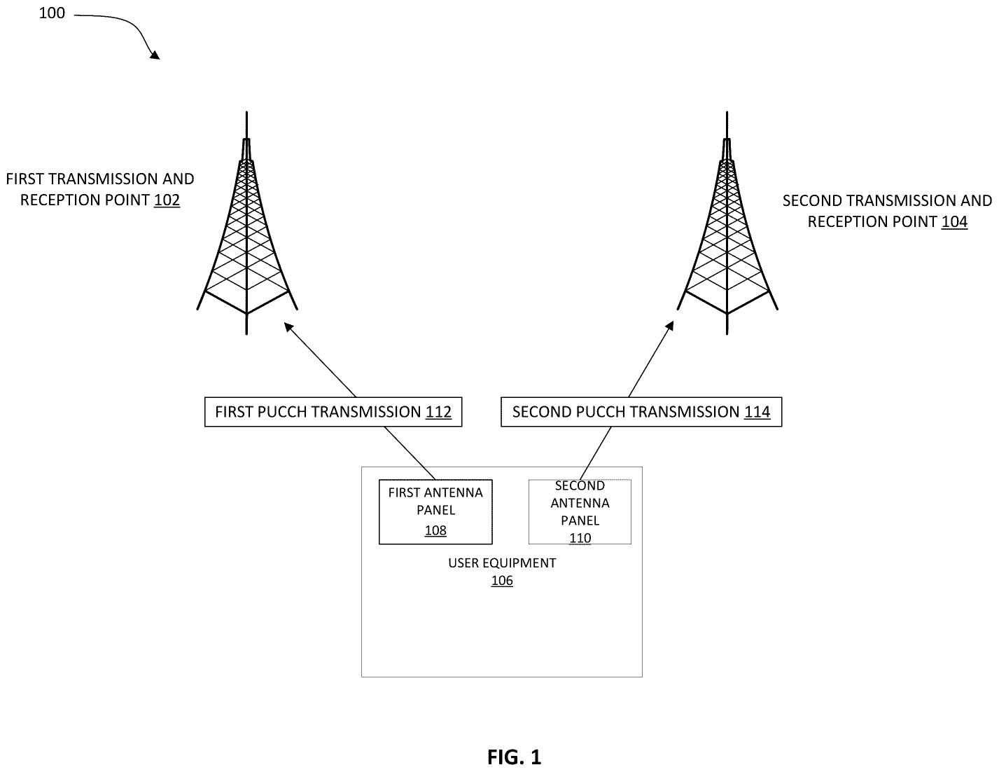

FIG. 1 is an illustration of a system 100 for simultaneous PUCCH transmission, according to one or more embodiments. The system 100 can include a first transmission and reception point (TRP) 102 and a second TRP 104, where each TRP can be arranged at one or more base stations for providing service to a geographic area (e.g., cell). The TRPs can communicate with the UE 106 through uplink (UL) and downlink (DL) communications. The TRPs can further communicate with each other through backhaul links.

The UE 106 can be located at a fixed position or be movable about inside and outside of the geographic area. The geographic can be, for example, a macro cell that can provide low-frequency coverage over miles, a small cell, including femtocell, picocell, and microcell, that can provide high-frequency coverage for a smaller area. It should be appreciated that although two TRPs are illustrated, in other embodiments, the system 100 can include more than two TRPs. The UE 106 can include a first antenna panel 108 and a second antenna panel 110. The UE 106 can further be configured to simultaneously transmit a first PUSCH transmission 112 through the first antenna panel 108 and a second PUSCH transmission 114 through the second antenna panel 110. In some instances, the first PUSCH transmission 112 and the second PUSCH transmission 114 are received at either the first TRP 102 or the second TRP 104. In other instances, the first PUSCH transmission is received at the first TRP 102, and the second PUSCH transmission is received at the second TRP 104.

The first TRP 102 and the second TRP 104 and the UE 106 can communicate with each other using component carriers (CCs). A CC includes multiple carriers that are used by a base station to configure the UE 106 for carrier aggregation (CA). The UE 106 can be configured with multiple UL CCs and DL CCs to be used for UL and DL transmissions.

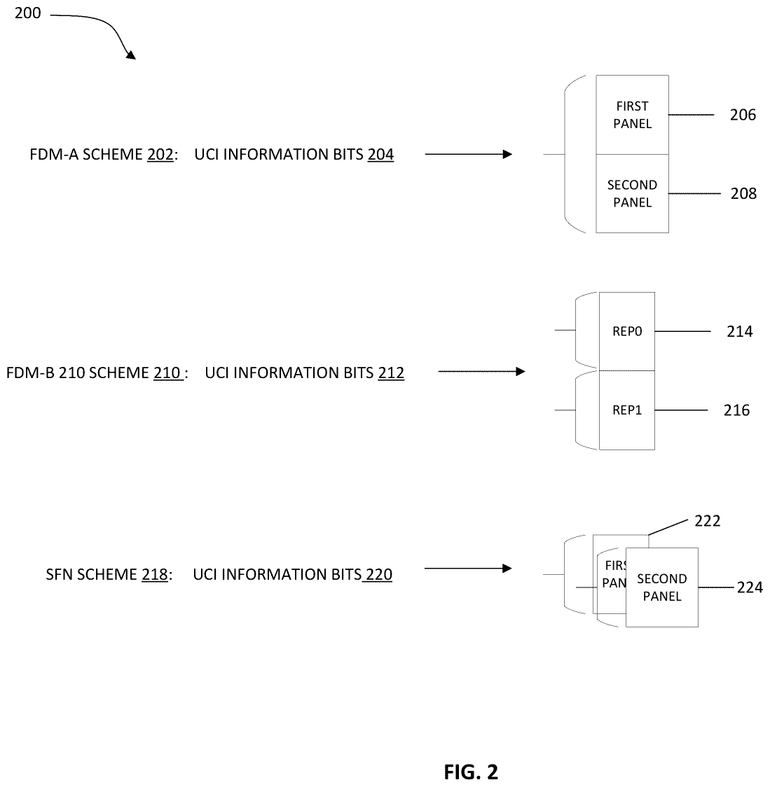

FIG. 2 is an illustration of simultaneous PUCCH transmission schemes 200, according to one or more embodiments. One or more of the schemes can employ various forms of multiplexing to combine multiple signals into one signal to be transmitted over a shared medium. Frequency division multiplexing can include dividing a total bandwidth into non-overlapping bands and using each non-overlapping band to carry a signal. A first ST×MP scheme can be a frequency division multiplexing scheme A (FDM-A) 202, in which the UCI information bits 204 are separated into two portions. The first portion (e.g., first PUCCH transmission) can be transmitted through a first antenna panel 206 (e.g., first antenna panel 108), and a second portion (e.g., second PUCCH transmission) can be transmitted through a second antenna panel 208 (e.g., second antenna panel). As described herein, a panel should be considered an antenna panel. Referring to FIG. 1, the UE 106 can transmit the first portion to the first TRP 102 via the first antenna panel 108 and the second portion to the second TRP 104 via the second antenna panel 110.

A second ST×MP scheme can be a frequency division multiplexing scheme B (FDM-B) 210, in which all of the UCI information bits are used to generate a first PUCCH transmission (Rep0) to be transmitted through a first panel 214, and a second PUCCH transmission (Rep1) can be transmitted through a second panel 216, where Rep1 is a repetition of Rep0. Referring to FIG. 1, the UE 106 can transmit the first PUCCH transmission (Rep0) to the first TRP 102 via the first antenna panel 108 and the second PUCCH transmission (Rep1) to the second TRP 104 via the second antenna panel 110.

A third ST×MP scheme can be a single frequency network (SFN) scheme 218, where a network of transmitters can each send the same signal over the same frequency. In this scheme, two sets of PUCCH resources can overlap in the frequency domain and the time domain. Furthermore, each PUCCH resource set can be associated with a different panel. Referring to FIG. 1, the UE 106 can transmit/encode UCI information bits 222 and transmit a first PUCCH transmission to the first TRP 102 via the first antenna panel 108 and a second PUCCH transmission to the second TRP 104 via the second antenna panel 110 using overlapping PUCCH resources.

A base station can provide an indication to a UE as to which ST×MP scheme to using various procedures. The following description and accompanying figures provide an explanation of two such procedures.

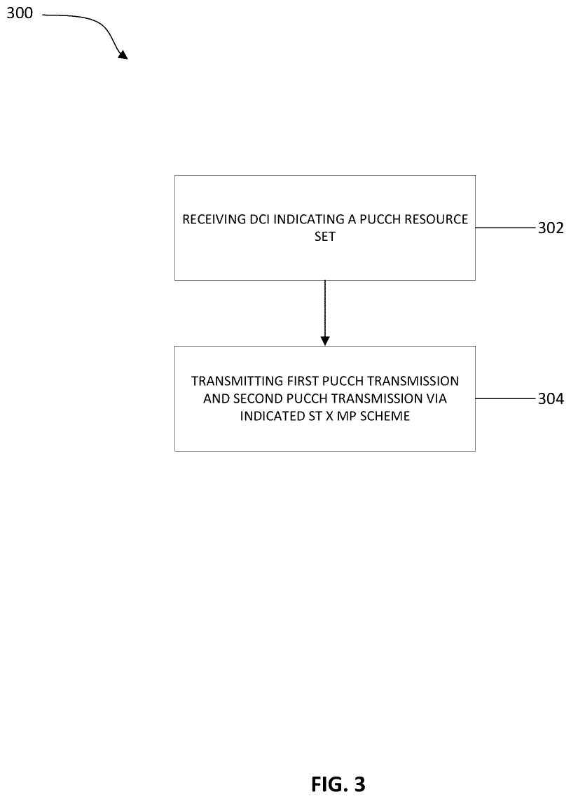

FIG. 3 is a process flow 300 for implementing an ST×MP scheme, according to one or more embodiments. This process is independent of PUCCH resource configuration. A base station can configure a UE to perform various ST×MP schemes (e.g., FDM-A, FDM-B, and SFN) via radio resource control (RRC). The UE can be indicated the ST×MP scheme via radio resource control (RRC) transmission. At 302, the process can include a UE receiving downlink control information (DCI) from a base station, that includes a PUCCH resource identification. In some instances, the UE can be configured to assume transmission to multiple TRPs (mTRP) and perform the ST×MP scheme indicated by RRC. In other instances, the UE is not configured to assume mTRP. In these instances, the UE can wait for an additional indication from DCI that the selected PUCCH resource set is for the ST×MP as indicated by RRC or single TRP (sTRP). If the DCI confirms the ST×MP scheme, the UE performs the scheme. IF DCI does not confirm the scheme, the UE ignores the RRC indication and transmits to an s-TRP. At 304, the process can include the UE transmitting a first PUCCH transmission and a second PUCCH transmission via the indicated scheme.

As an illustration, RRC can send an indication to the UE to use FDM-A. A base station can transmit DCI with an indication to use a PUCCH resource set. As indicated above, the UE can be configured to assume ST×MP and performs the ST×MP scheme with FDM-A over the indicated PUCCH resource set. Alternatively, UE can wait for the indication from DCI as to whether the selected PUCCH resource is indicated for the ST×MP scheme with FDM-A. If the DCI confirms that the ST×MP scheme, the UE n performs the ST×MP scheme with FDM-A. If, however, the DCI does not confirm that the ST×MP scheme, the UE ignores the RRC indication of the ST×MP scheme with FDM-A.

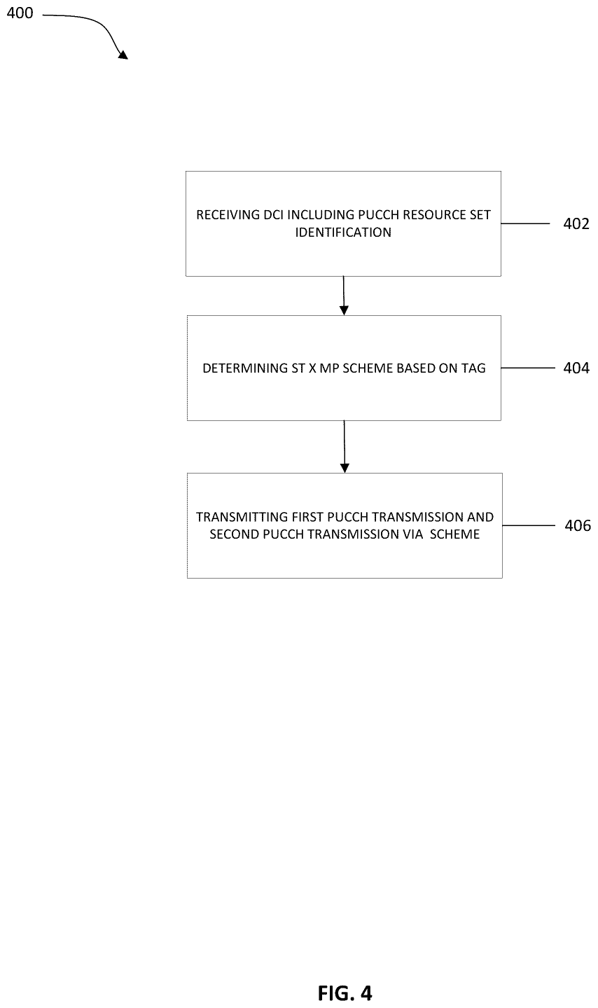

FIG. 4 is a process flow 400 for implementing an ST×MP scheme, according to one or more embodiments. The base station can configure a PUCCH resource set via a RRC PUCCH configuration. The base station can tag a resource set to indicate the ST×MP scheme during the resource configuration. In some instances, the base station can tag the same PUCCH resource sets with different ST×MP schemes. At 402, the process can include the UE receiving a DCI with an indication of the PUCCH resource set identification. AT 404, the process can include, the UE determining the ST×MP scheme based on the PUCCH resource set tag. At 406, the process can include the UE transmitting a first PUCCH transmission and a second PUCCH transmission via the indicated scheme.

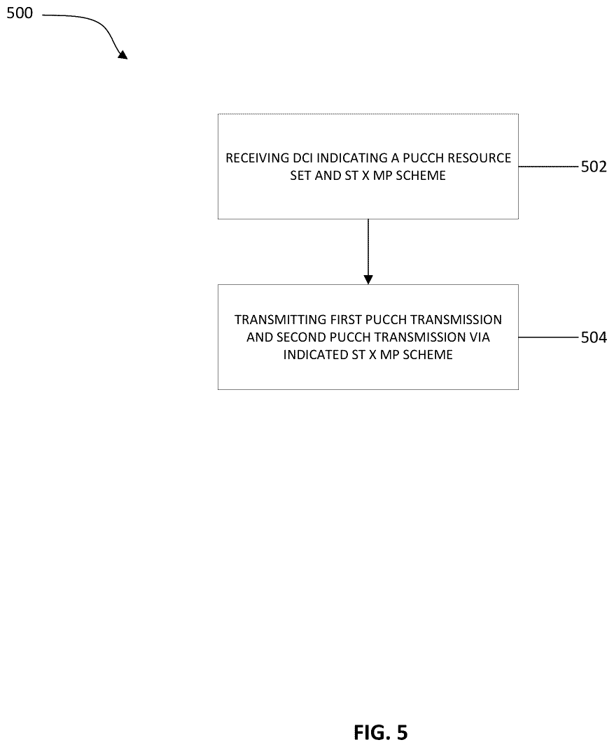

FIG. 5 is a process flow 500 for implementing an ST×MP scheme, according to one or more embodiments. At 502, the process can include a UE receiving DCI from a base station, that includes an indication of a PUCCH resource identification and an ST×MP scheme. At 504, the process can include the UE transmitting a first PUCCH transmission and a second PUCCH transmission via the indicated scheme. If this procedure is used, the DCI or MAC-CE can include more than one bit to indicate which ST×MP scheme to use, rather than one indicator bit used in the first procedure. For example, FDM-A can be indicated by “00,” FDM-B can be indicated by “01,” and SFN can be indicated by “10.”

The embodiments described herein provide various methods for frequency domain (FD) resource determination. A first method includes a UE receiving DCI (or MAC-CA for semi-persistent CSI (SP-CSI) or RRC for persistent CSI (R-CSI) from a base station. The DCI can identify a PUCCH resource set that is RRC associated with the following parameters: format, starting physical resource block (PRB), second PRB, and number of PRBs. The DCI can indicate the PUCCH format, which can be the same format to both FD partitions (PUCCH 1 (e.g., first PUCCH transmission 112) and PUCCH 2 (e.g., second PUCCH transmission 114)). For example, consider an instance in which a channel can be divided into twelve frequencies, frequencies 0-4 can be for the first FD partition, frequencies 8-14 can be for the second FD partition and frequencies 5-9 can be for a guard band.

The starting PRB can represent a starting PRB for the first FD part (e.g., PUCCH 1). The second PRB can represent the starting PRB for the second FD partition (e.g., PUCCH 2). This parameter can be similar to the legacy second PRB parameter for frequency hopping for PUCCH. However, legacy frequency hopping assumes frequency hops at different times, whereas as described herein, frequency hopping can be performed at the same time. The number of PRBs can be the same for the first FD partition and the second FD partition. This parameter is contingent on the format parameter. For PUCCH formats 0, 1, and 4, there can be one PRB per FD partition. For PUCCH formats 2 and 3, there can be up to sixteen PRBs per FD partition.

Alternatively, FD resource determination can include the base station dividing a PUCCH resource, with “M” number of resource blocks, MRB, into two FD portions. The first number of resource blocks, ceil (M_{RB}/2), can be associated with a first FD partition, and M_{RB}-ceil (M_{RB}/2) cyclic shifts can be associated with the second FD partition. For PUCCH formats 0, 1, and 4, the M_{RB} can be more than one. Alternatively, if M becomes too large for, PUCCH formats 0, 1, and 4 can be configured to not support FDM-A and FDM-B schemes.

The following applies to embodiments in which an FDM-A scheme is selected, and one PUCCH resource set is partitioned into FDs to be transmitted through two different UE antenna panels. The UE can generate UCI information bits having length “A,” in the same manner as legacy UCI information bit generation with the exception that the bits can be divided into two FD partitions. A first set of UCI information bits, ceil (A/2), can be encoded and mapped to a first FD partition. A second set of UCI information bits, A-ceil (A−2), can be encoded and mapped to a second FD partition. For this procedure, the UE can separately multiplex each set of UCI information bits. Furthermore, prior to multiplexing, the UE can perform channel encoding separately for each set of UCI information bits. It should be noted that this procedure cannot be supported if A=1, as A would be indivisible. Additionally, DMRS estimation and sequence generation can be performed per FD partition (e.g., PUCCH 1 and PUCCH 2).

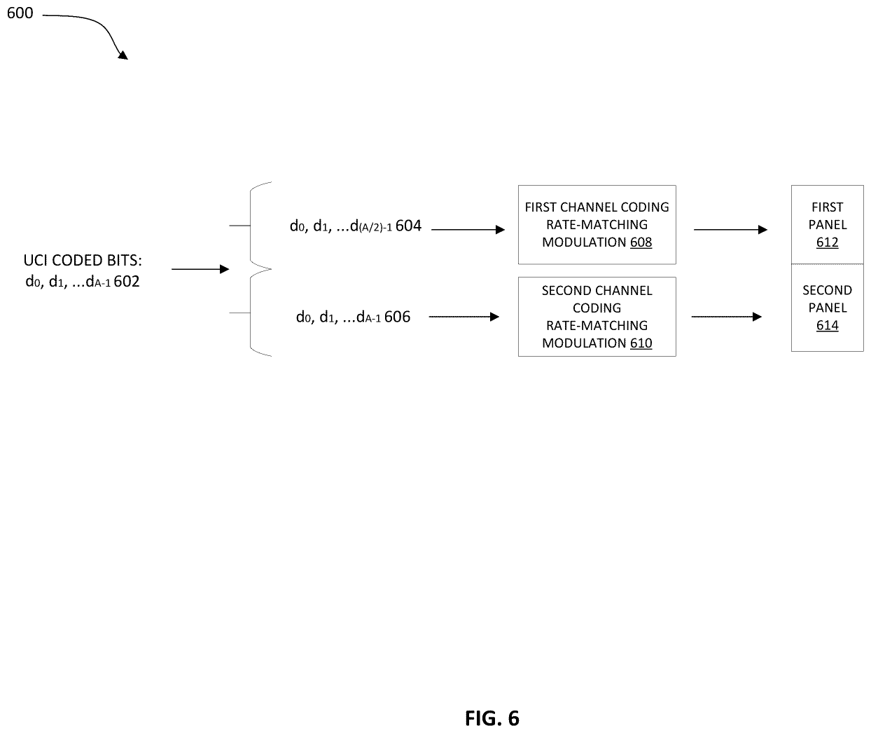

FIG. 6 is an illustration 600 of an ST×MP scheme, according to one or more embodiments. In particular, FIG. 6, is an illustration of the above procedure. The UE can generate a sequence of UCI coded bits 602 (d₀-d_{A-1}). The UE can further generate a first partition 604 that includes UCI coded bits d₀-d_{((A/2)-1)} and a second partition 606 that includes UCI coded bits d_{A/2}-d_{A-1}. The UE can perform a first channel coding, rate-matching, and modulation 608 on the first partition 604. The UE can also separately perform a second channel coding, rate-matching, and modulation 610 on the second partition 606. The two sets of operations 608, 610 can be performed in series or in parallel given UE's the capabilities. The operations 608, 610 can result in two sets of coded symbols, where one set of coded symbols is used for PUCCH1 and the other set of coded symbols is used for PUCCH2. The UE can transmit PUCCH 1 through the first panel 612 and PUCCH 2 through the second panel 614.

Alternatively, to the above process, the UE can generate a sequence of UCI information bits and encode the bits to form a sequence of encoded symbols. The UE can then divide the sequence of encoded symbols to be mapped to two partitions. The first set of encoded symbols (e.g., ceil (N/2), where N is a number of encoded symbols) can be mapped to a first FD partition. The second set of encoded symbols N-ceil (N−2) can be mapped to a second FD partition. For this procedure, DMRS estimation and sequence generation can be performed across all resources elements (REs).

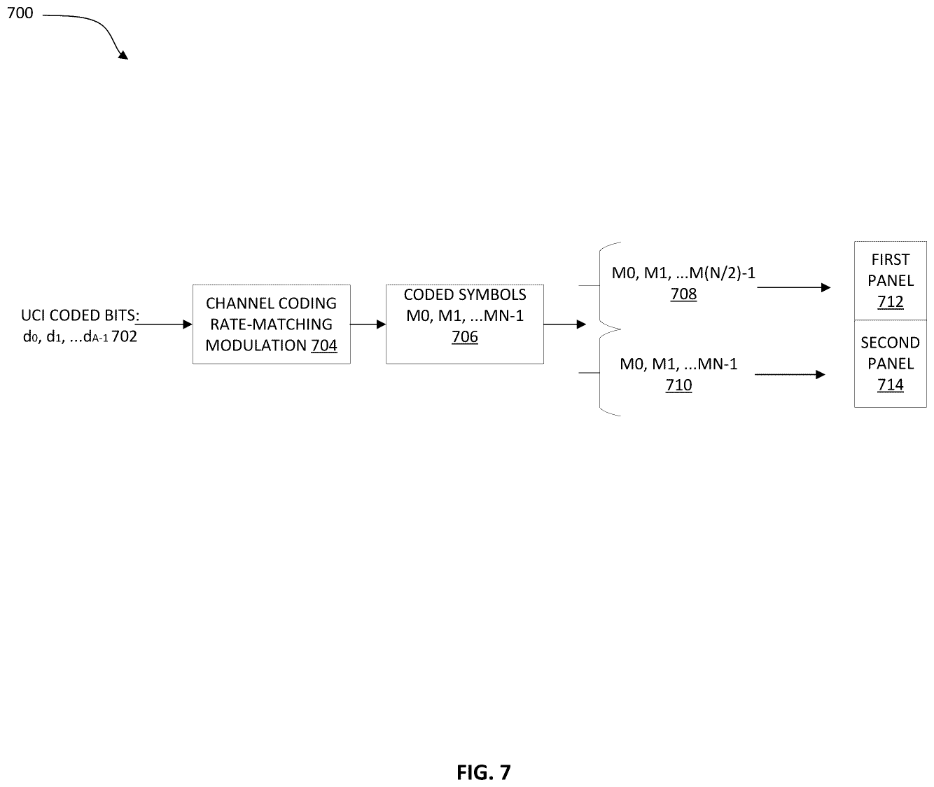

FIG. 7 is an illustration of an ST×MP scheme with FDM-A 700, according to one or more embodiments. In particular, FIG. 7 is an illustration of the above-described procedure. As described above, the UE can process the sequence of UCI coded bits 702 by performing channel coding, rate-matching, and modulation 704 to create a sequence of coded symbols 706. The UE can then divide the coded symbols 706 into a first partition 708 and a second partition 710. For example, the coded symbols 706 can include coded symbols m₀-mₙ₋₁, where mᵢ is a coded symbol. The first partition 708 can include coded symbols m₀-d_{(m/2)-1)} associated with PUCCH1 and the second partition 710 can include coded symbols m_{n/2}-mₙ₋₁ associated with PUCCH2. The UE can transmit PUCCH 1 through the first panel 712 and PUCCH 2 through the second panel 714.

For FDM-A (and FDM-B), the following RRC parameters can be independently indicated to the UE for PUCCH1 and PUCCH2. For PUCCH format 0 or 1, the base station can indicate the initial cyclic shift for PUCCH1 and the second cyclic shift for PUCCH2. For PUCCH format 1, the base station can further provide the UE with an indication of a time domain orthogonal cover code (OCC) parameter for PUCCH1 and a second time domain parameter for PUCCH2. For PUCCH format 4, the base station can indicate occ-Length and occ-Index. The base station can further provide the UE with an indication of a number of symbols parameter and a same starting symbol index parameter for PUCCH1 and PUCCH2, regardless of PUCCH format.

Another issue to consider is if the UE is scheduled to transmit two PUCCH transmissions, in which one PUCCH transmission can collide with the other PUCCH transmission. A UE can be scheduled to transmit a first PUCCH transmission over more than one slot and at least one second PUCCH transmission over more or more slots. Under the current standards (3GPP TS 38.213, 9.2.6), if one or more of the slots overlap, the UE will transmit a PUCCH transmission based on UCI priority.

Embodiments described herein address the above-referenced issues through a UCI multiplexing procedure for resolving potential collisions.

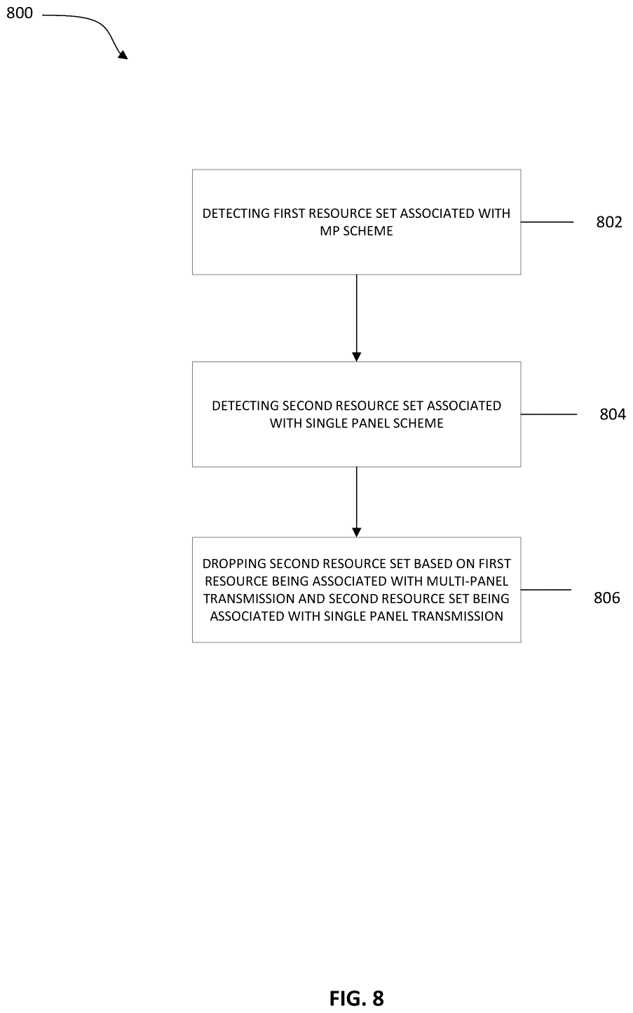

FIG. 8 is a process flow 800 for implementing an ST×MP scheme, according to one or more embodiments. A first resource set, PUCCH_{A}, can be associated with multi-panel transmissions and a second resource set, PUCCH_{B}, can be associated with single panel transmission. PUCCH_{A} can be indicated with an ST×MP scheme with FDM-A. At 802, the UE can detect that the first PUCCH resource set is associated with multi-panel transmission. At 804, the UE can detect that the second PUCCH resource set is associated with single panel transmission. At 804, the UE can drop the second PUCCH resource set, and consequently an associated PUCCH transmission. The UE can further transmit the PUCCH transmission associated with the first PUCCH resource set. This can be regardless of existing multiplexing/prioritization rules. This can further be performed regardless of the contents of the first PUCCH resource set and the second PUCCH resource set (e.g., UCI priority). Alternatively, only the contents of the second PUCCH resource set having a threshold priority (e.g., HARQ-ACK) are multiplexed over the first PUCCH resource set, if the second PUCCH resource set is for a single panel transmission.

Alternatively, the UE can follow existing UCI multiplexing and dropping rules (if the procedure illustrated by FIG. 6 is adopted into a Technical Standard). Yet another alternative is, if the procedure illustrated by FIG. 7 is adopted into a Technical Standard, the UE can prioritize the first PUCCH resource set and drop the second PUCCH resource set. In yet even another alternative, only the contents of the second PUCCH resource set having a threshold priority (e.g., HARQ-ACK) are multiplexed by UE over the first PUCCH resource set, if the second PUCCH resource set is for a single panel transmission.

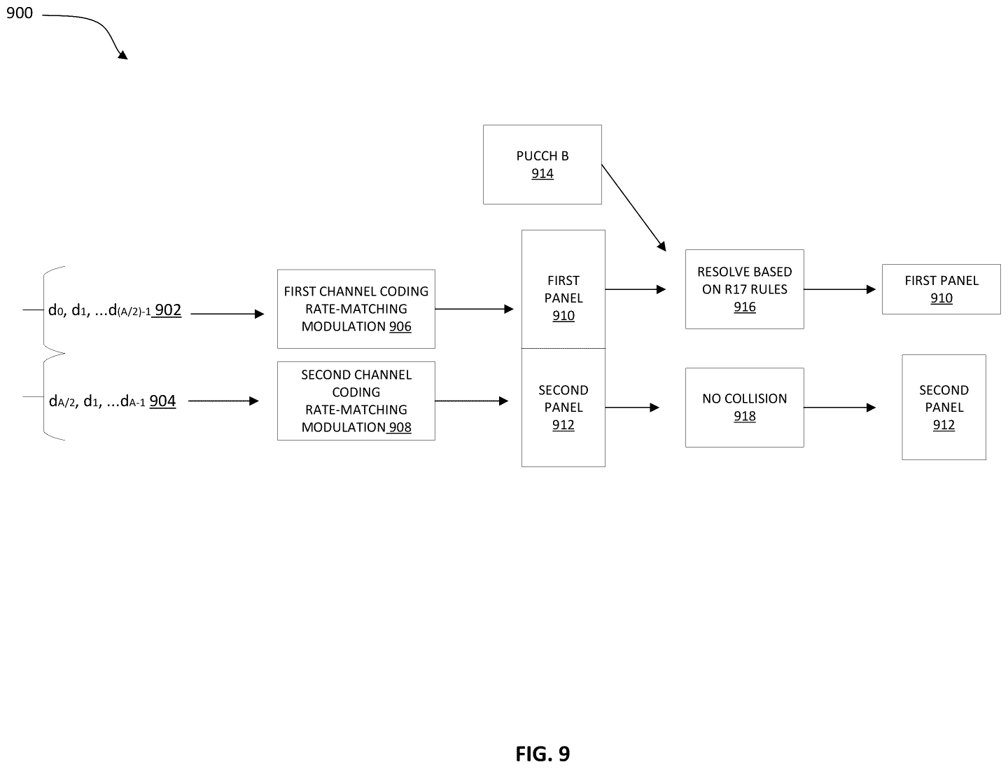

FIG. 9 is a process flow 900 for implementing an ST×MP scheme, according to one or more embodiments. In particular, FIG. 9 is an illustration of the alternative, in which the procedure illustrated by FIG. 6 is adopted into a Technical Standard. The UE can divide UCI information encoded bits for a first PUCCH transmission, into a first partition 902 and a second partition 904. The UE can perform a first channel coding, rate-matching, and modulation 906 on the first partition 902. The UE can also separately perform a second channel coding, rate-matching, and modulation 908 on the second partition 904. The first PUCCH transmission can be scheduled to be transmitted through a first panel 910 and a second panel 912. The second PUCCH transmission 914 can also be scheduled to be transmitted through the first panel 910. However, one or more slots of the first PUCCH transmission, through the first panel 910 overlap with one or more slots of the second PUCCH transmission through the first panel 910 in the time domain. The potential collision between the first PUCCH transmission and the second PUCCH transmission 914 at the first panel 910 can be resolved based on release 17 rules 916. The second partition 904 was scheduled to be transmitted through the second panel 912 and therefore, there is no collision 918 with the second PUCCH transmission 914. Therefore, the UE can transmit the second partition portion of the first PUCCH transmission through the second panel 912.

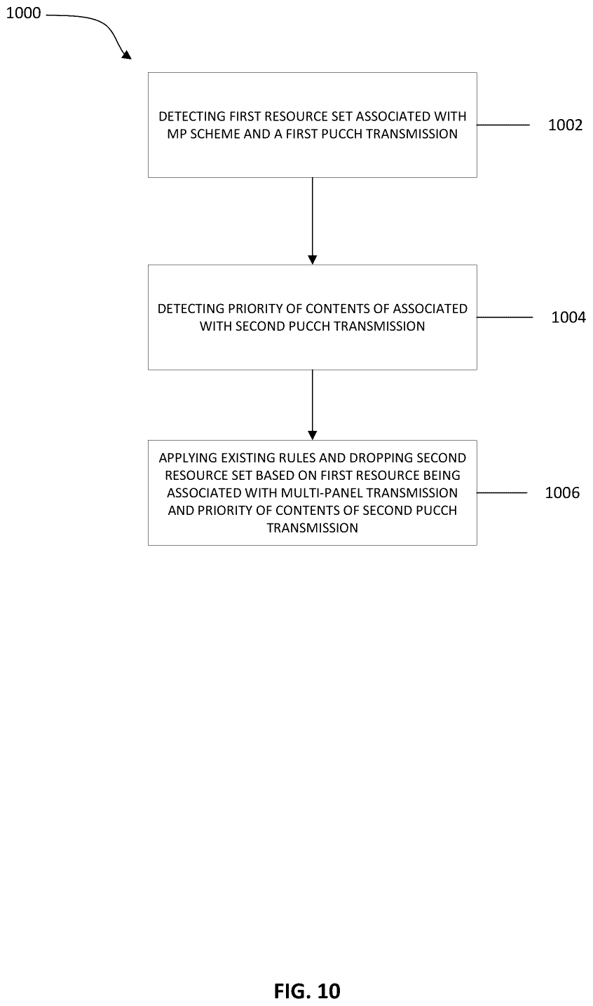

FIG. 10 is a process flow 1000 for implementing an ST×MP scheme, according to one or more embodiments. A first PUCCH resource set can be associated with multi-panel transmissions and a second PUCCH resource set can be associated with single panel transmission. The first PUCCH resource set can be indicated with an ST×MP scheme with FDM-B. At 1002, the process can include the UE detecting that the first PUCCH resource set is associated with a MP scheme and a first PUCCH transmission. At 1004, the process can include the UE detecting a priority of contents associated with a second PUCCH transmission (e.g., UCI priority). At 1006, the process can include the UE applying existing rules per panel and dropping the second PUCCH transmission based on the first PUCCH transmission being a multi-panel transmission and the second PUCCH transmission not including a higher priority content. Alternatively, the UE can drop the second PUCCH transmission based on the first PUCCH transmission being a multi-panel transmission and the second PUCCH transmission being a single panel transmission, regardless of the content's priority. In the instance, that the first PUCCH resource set is indicated for SDM (SFN), the UE can follow the above procedure illustrated in FIG. 10.

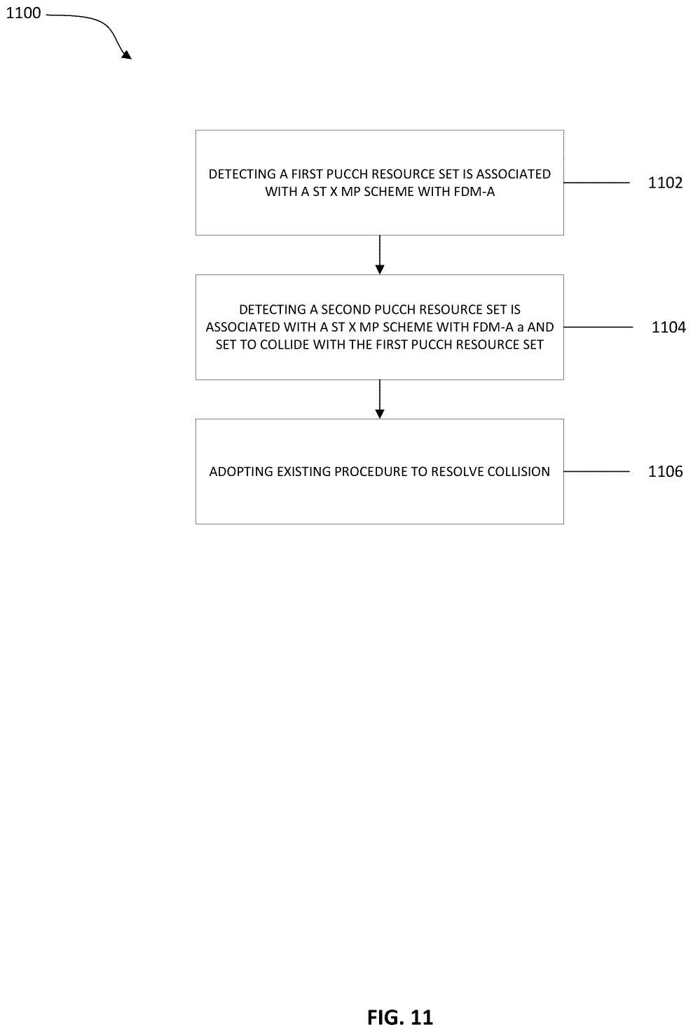

FIG. 11 is a process flow 1100 for implementing an ST×MP scheme, according to one or more embodiments. A first PUCCH resource set and a second PUCCH resource set can overlap in tap, where both sets are associated with multi-panel transmission. The UE does not expect overlapping scheduling with different ST×MP scheme (e.g., FDM-A and FDM-B). At 1102, the process can include the UE detecting that the first PUCCH resource set is associated with an ST×MP scheme with FDM-A. At 1104, the process can include the UE detecting that the second PUCCH resource set is associated with an ST×MP scheme with FDM-A and set to collide with the first PUCCH resource set. At 1106, the process can include the UE adopting existing procedure to resolve the collision. The resultant PUCCH, in this case will also by an ST×MP with FDM-A.

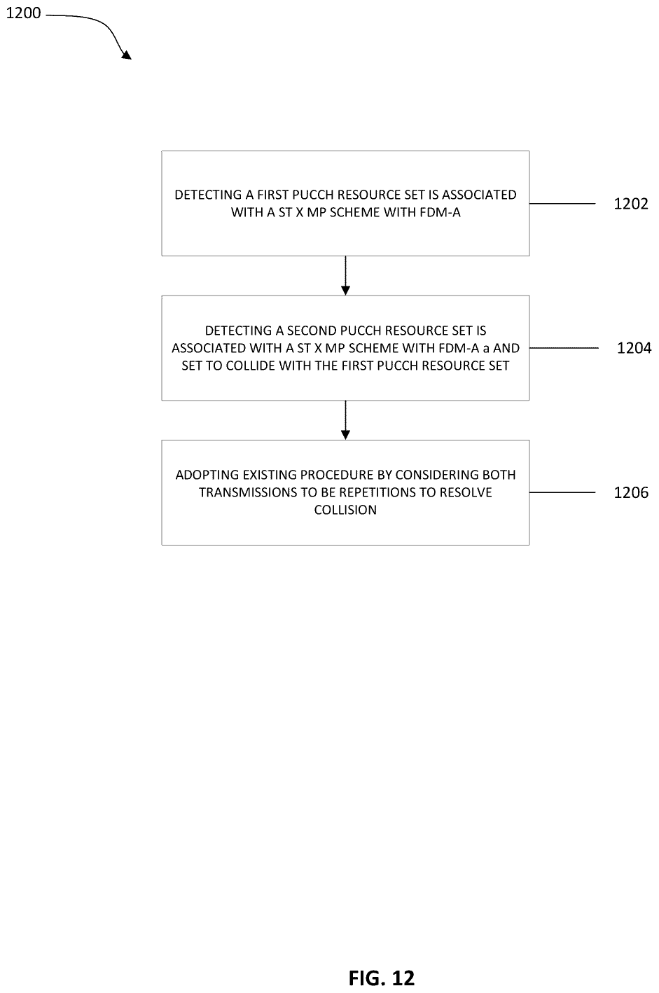

FIG. 12 is a process flow 1200 for implementing an ST×MP scheme, according to one or more embodiments. A first PUCCH resource set and a second PUCCH resource set can overlap in tap, where both sets are associated with multi-panel transmission. The UE does not expect overlapping scheduling with different ST×MP scheme (e.g., FDM-A and FDM-B). At 1102, the process can include the UE detecting that the first PUCCH resource set is associated with a ST×MP scheme with FDM-A. At 1104, the process can include the UE detecting that the second PUCCH resource set is associated with an ST×MP scheme with FDM-A and set to collide with the first PUCCH resource set. At 1106, the process can include the UE adopting existing procedure by considering both transmissions to be with repetitions to resolve the collision. Therefore, one transmission will survive and the other will be dropped based on content priority or the first symbol of each PUCCH transmission. Alternatively, the UE can apply existing procedures per panel by assuming overlapping per panel without repetitions. Therefore, one transmission will survive (using ST×PM with FDM-B) and the other will be dropped. In the instance, that the two PUCCH resource sets are indicated for SDM (SFN), the UE can follow the above procedure illustrated in FIG. 11.

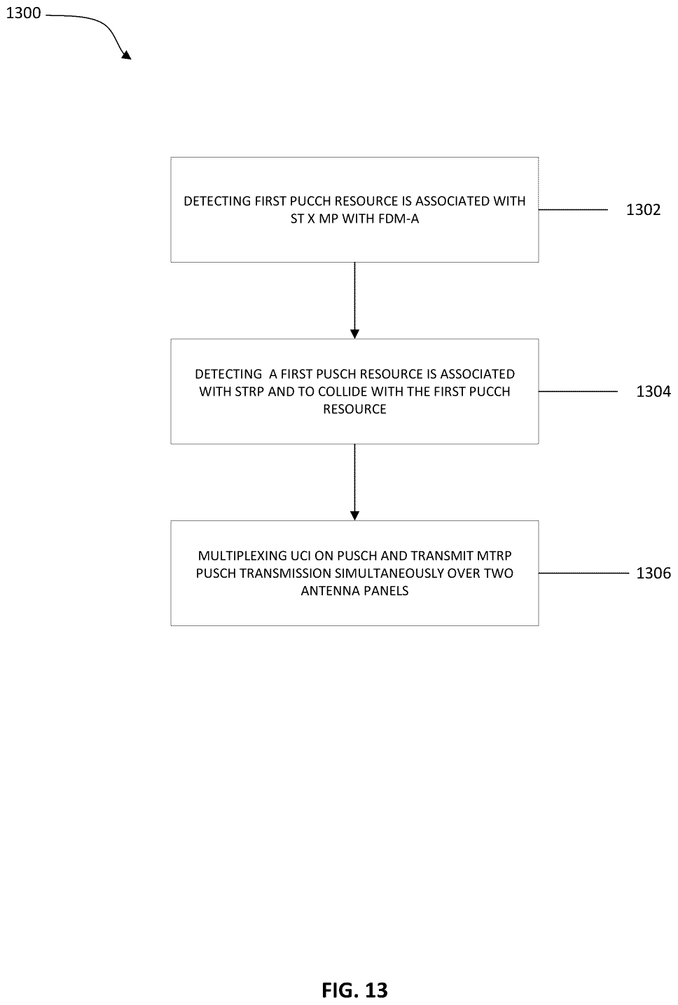

FIG. 13 is a process flow 1300 for implementing an ST×MP scheme, according to one or more embodiments. A first PUCCH resource that is associated with ST×MP can overlap in time with a second PUCCH resource that is associated with sTRP. At 1302, the procedure can include the UE detecting a first PUCCH resource is associated with ST×MP with FDM-A. At 1304, the process can include the UE detecting a first PUSCH resource is associated with sTRP and to collide with the first PUCCH resource. At 1306, the process can include the UE multiplexing UCI on a PUSCH transmission and simultaneously transmitting mTRP PUSCH transmissions over two antenna panels to avoid collision.

Alternatively, if the procedure illustrated by FIG. 6 is adopted into a Technical Standard, the UE can perform UCI multiplexing over the PUSCH transmission only, and only for the associated panel, the other panel can transmit a PUCCH transmission. If the procedure illustrated by FIG. 7, is adopted into a Technical Standard, the UE can either drop the PUSCH transmission or use the process described by FIG. 13.

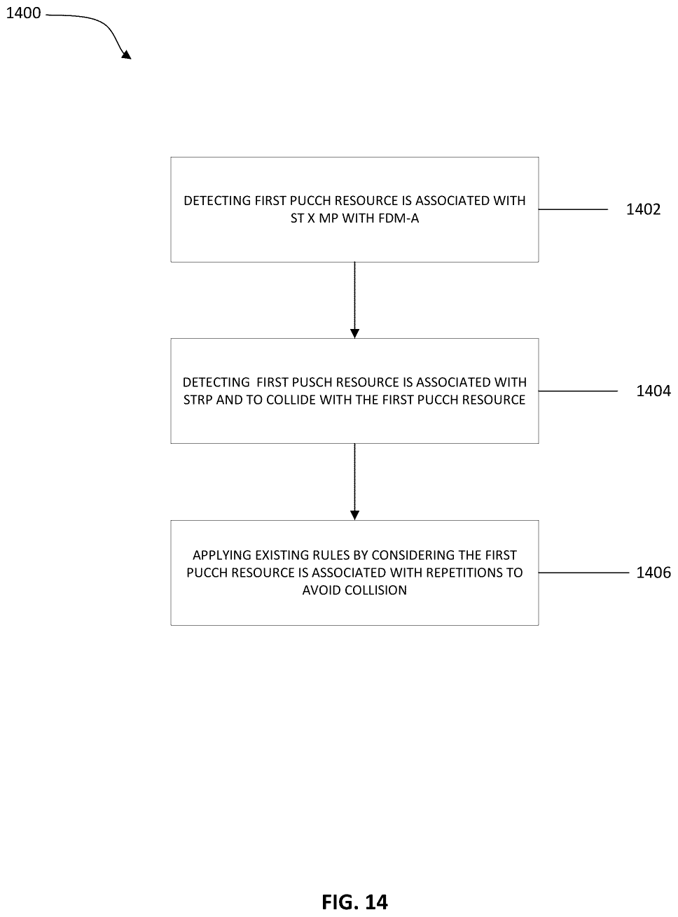

FIG. 14 is a process flow 1400 for implementing an ST×MP scheme, according to one or more embodiments. A first PUCCH resource that is associated with ST×MP can overlap in time with a first PUSCH resource that is associated with sTRP. At 1402, the procedure can include the UE detecting a first PUCCH resource is associated with ST×MP with FDM-B. At 1404, the process can include the UE detecting a second PUCCH resource is associated with sTRP and to collide with the first PUCCH resource. At 1406, the process can include the UE applying existing rules by considering the first PUCCH resource to be with repetitions to avoid collision, thus the PUSCH will be dropped. Alternatively, the UE can apply existing rules by assuming overlapping per panel is without repetitions. The UCI on the PUCCH repetition that shares the same panel index with PUSCH is multiplexed on PUSCH, the other PUCCH repetition is transmitted on PUCCH from the other panel. In the instance, that the first PUCCH resource is indicated for SDM (SFN), the UE can follow the above procedure illustrated in FIG. 14.

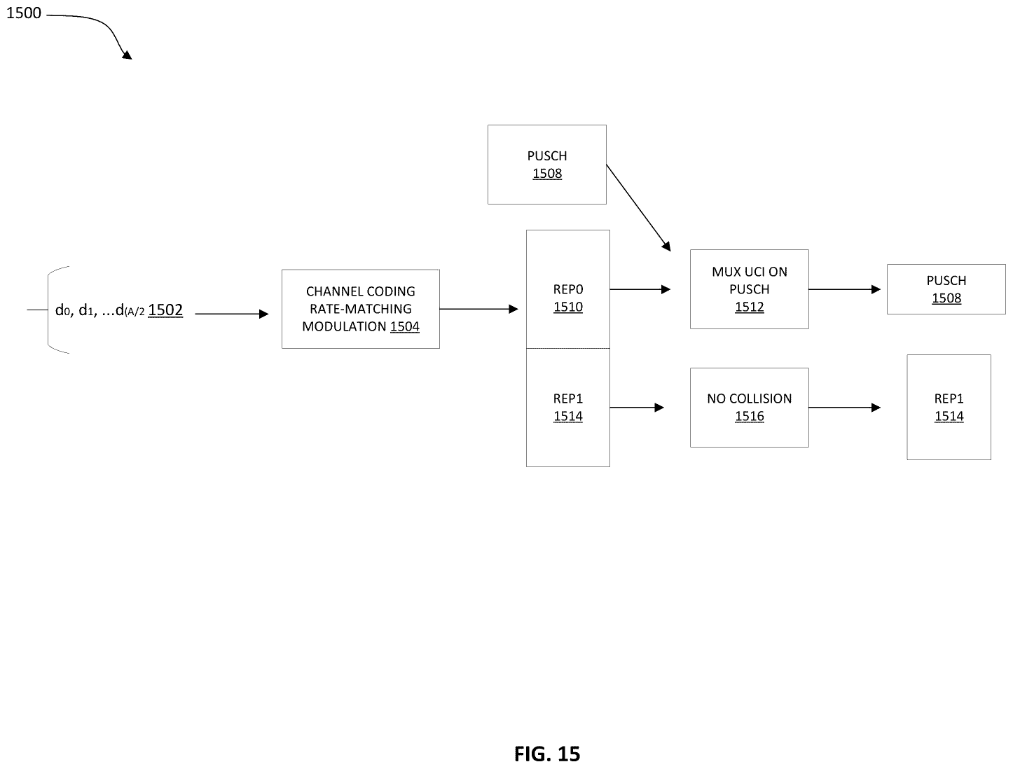

FIG. 15 is an illustration 1500 of an ST×MP scheme, according to one or more embodiments. In particular, FIG. 15 is an illustration of the alternative described in FIG. 14. The encoded UCI information bits 1502 associated with PUCCH_{A} can be processed through channel coding rate matching, and modulation 1504 by a UE. A resource set, PUSCH, 1506 overlaps with a panel associated with PUCCH_{A} and to be used to transmit a repetition (REP₀) 1510 of a PUCCH transmission. To resolve the overlapping, the UE assumes that the overlapping resources are without repetition and multiplexes the UCI on PUSCH 1512. The PUCCH repetition is transmitted via PUSCH 1508. The other PUCCH repetition (REP1) 1514 has no collision 1516 and is transmitted via PUCCH.

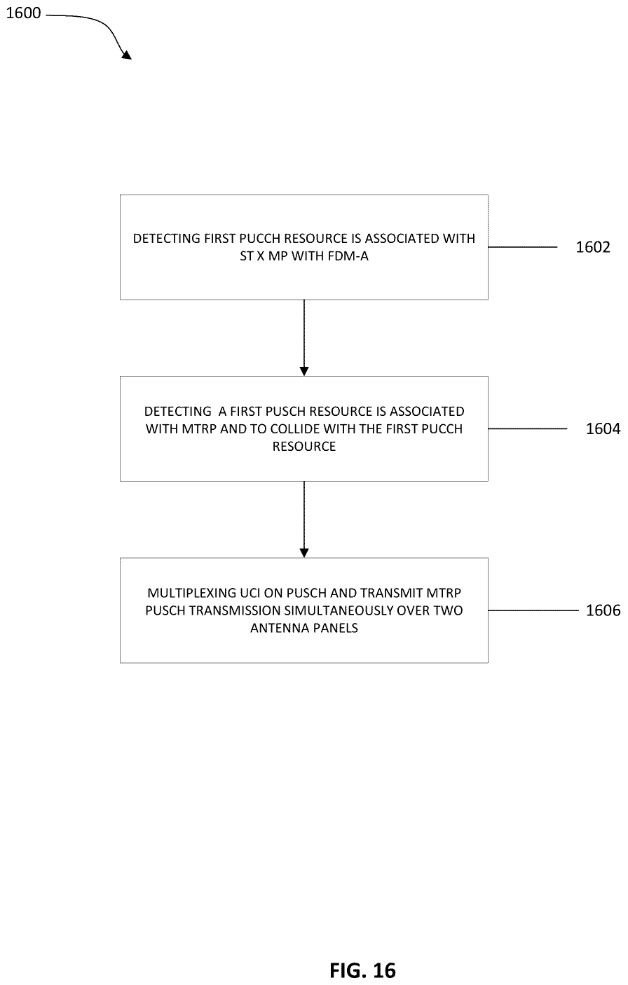

FIG. 16 is a process flow 1600 for implementing an ST×MP scheme, according to one or more embodiments. A first PUCCH resource that is associated with ST×MP can overlap in time with a first PUSCH resource that is associated with mTRP. At 1602, the procedure can include the UE detecting a first PUCCH resource is associated with ST×MP with FDM-A. At 1604, the process can include the UE detecting a first PUSCH resource is associated with mTRP and to collide with the first PUCCH resource. At 1606, the process can include the UE multiplexing UCI on a PUSCH transmission and simultaneously transmitting mTRP PUSCH transmissions over two antenna panels to avoid collision. The m-TRP PUSCHs may or may not be simultaneous.

Alternatively, if the procedure illustrated by FIG. 6 is adopted into a Technical Standard, the UE can perform UCI multiplexing over each PUSCH separately, and only for the associated panel, the other panel can transmit a PUCCH transmission. The m-TRP PUSCHs may or may not be simultaneous. If the procedure illustrated by FIG. 7, is adopted into a Technical Standard, the UE can either drop the PUSCH transmission or use the process described by FIG. 16.

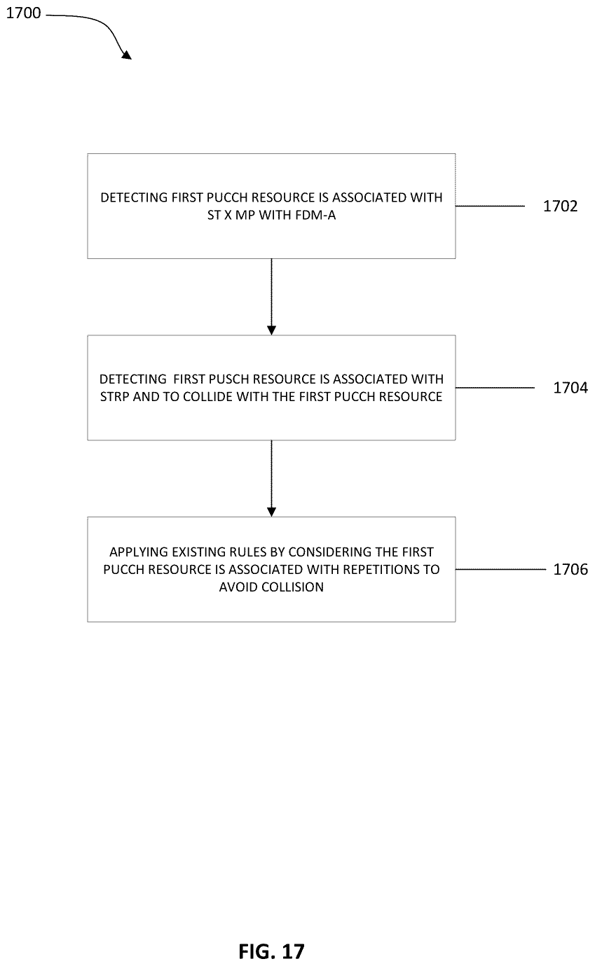

FIG. 17 is a process flow 1700 for implementing an ST×MP scheme, according to one or more embodiments. A first PUCCH resource that is associated with ST×MP can overlap in time with a first PUSCH resource that is associated with sTRP. At 1702, the procedure can include the UE detecting a first PUCCH resource is associated with ST×MP with FDM-B. At 1704, the process can include the UE detecting a second PUCCH resource is associated with sTRP and to collide with the first PUCCH resource. At 1706, the process can include the UE applying existing rules by considering the first PUCCH resource to be with repetitions to avoid collision, thus the PUSCHs will be dropped. Alternatively, the UE can apply existing rules by assuming overlapping per panel is without repetitions. The UCI on the PUCCH repetition that shares the same panel index with PUSCH is multiplexed on PUSCH, the other PUCCH repetition is transmitted on PUCCH from the other panel. In the instance, that the first PUCCH resource is indicated for SDM (SFN), the UE can follow the above procedure illustrated in FIG. 17.

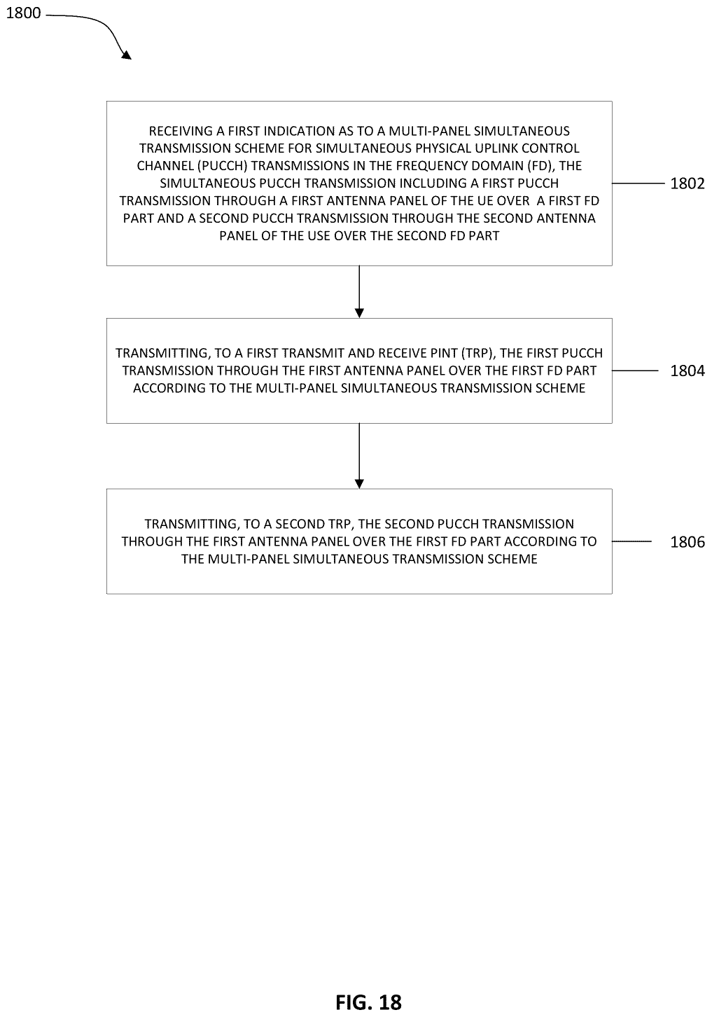

FIG. 18 is a process flow for implementing an ST×MP scheme, according to one or more embodiments. At 1802, the process can include a UE receiving a first indication as to a multi-panel simultaneous transmission scheme for simultaneous physical uplink control channel (PUCCH) transmissions in the frequency domain (FD), the simultaneous PUCCH transmissions including a first PUCCH transmission through the first antenna panel of the UE over a first FD part and a second PUCCH transmission through the second antenna panel of the UE over a second FD part. At 1804, the process can include the UE transmitting, to a first transmit and receive point (TRP), the first PUCCH transmission through first antenna panel over the first FD part according to the multi-panel simultaneous transmission scheme. At 1806, the process can include transmitting, to a second TRP, the second PUCCH transmission through the second antenna panel over the second FD part according to the multi-panel simultaneous transmission scheme, the second PUCCH transmission being transmitted simultaneously with the first PUCCH transmission.

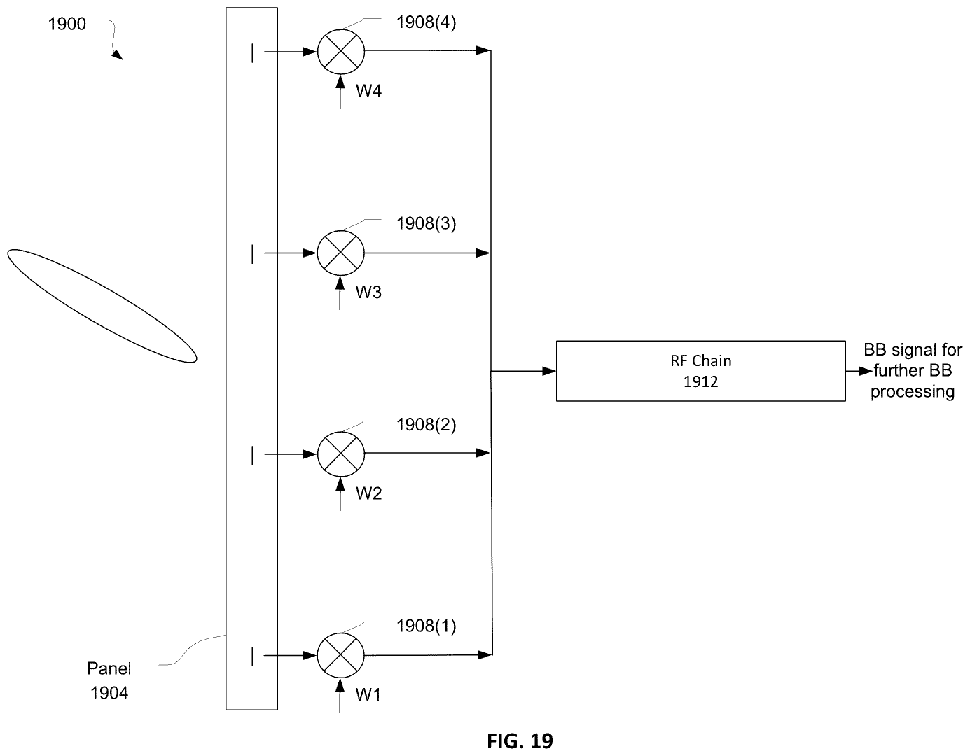

FIG. 19 illustrates receive components 1900 of the UE 1906, in accordance with some embodiments. The receive components 1900 may include an antenna panel 1904 that includes a number of antenna elements. The panel 1904 is shown with four antenna elements, but other embodiments may include other numbers

The antenna panel 1904 may be coupled to analog beamforming (BF) components that include a number of phase shifters 1908(1)-1908(4). The phase shifters 1908(1)-1908(4) may be coupled with a radio-frequency (RF) chain 1912. The RF chain 1912 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1908(1)-1908(4) to provide a receive beam at the antenna panel 1904. These BF weights may be determined based on the channel-based beamforming.

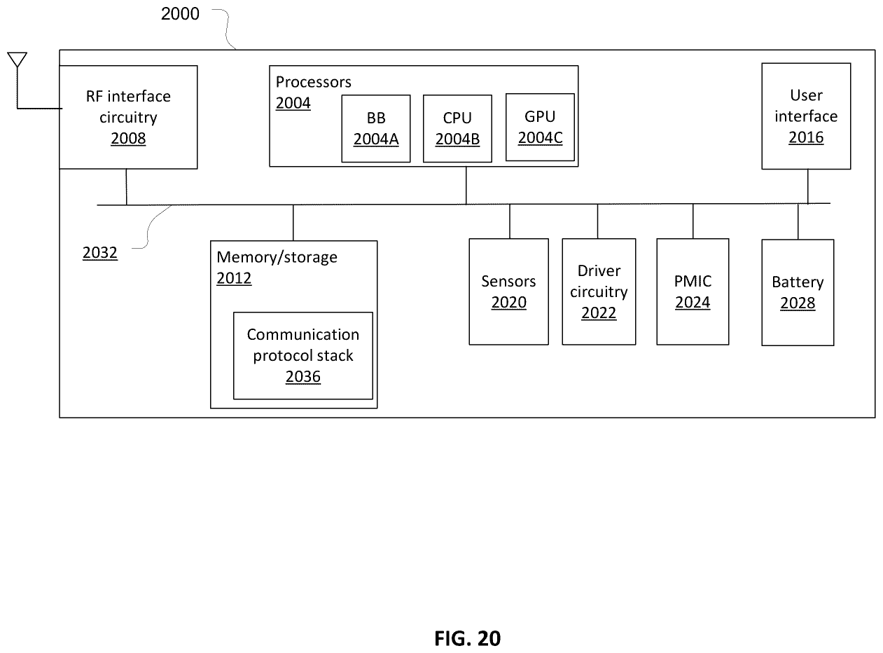

FIG. 20 illustrates a UE 2000, in accordance with some embodiments. The UE 2000 may be similar to and substantially interchangeable with UE 1906 of FIG. 19.

Similar to that described above with respect to UE 2000, the UE 2000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 2000 may include processors 2004, RF interface circuitry 2008, memory/storage 2012, user interface 2016, sensors 2020, driver circuitry 2022, power management integrated circuit (PMIC) 2024, and battery 2028. The components of the UE 2000 may be implemented as integrated circuits (ICs), portions thereof, discrete electronic devices, or other modules, logic, hardware, software, firmware, or a combination thereof. The block diagram of FIG. 20 is intended to show a high-level view of some of the components of the UE 2000. However, some of the components shown may be omitted, additional components may be present, and different arrangements of the components shown may occur in other implementations.

The components of the UE 2000 may be coupled with various other components over one or more interconnects 2032, which may represent any type of interface, input/output, bus (local, system, or expansion), transmission line, trace, optical connection, etc. that allows various circuit components (on common or different chips or chipsets) to interact with one another.

The processors 2004 may include processor circuitry such as, for example, baseband processor circuitry (BB) 2004A, central processor unit circuitry (CPU) 2004B, and graphics processor unit circuitry (GPU) 2004C. The processors 2004 may include any type of circuitry or processor circuitry that executes or otherwise operates computer-executable instructions, such as program code, software modules, or functional processes from memory/storage 2012 to cause the UE 2000 to perform operations as described herein.

In some embodiments, the baseband processor circuitry 2004A may access a communication protocol stack 2036 in the memory/storage 2012 to communicate over a 3GPP compatible network. In general, the baseband processor circuitry 2004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 2008.

The baseband processor circuitry 2004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 2004A may also access group information 2024 from memory/storage 2012 to determine search space groups in which a number of repetitions of a PDCCH may be transmitted.

The memory/storage 2012 may include any type of volatile or non-volatile memory that may be distributed throughout the UE 2000. In some embodiments, some of the memory/storage 2012 may be located on the processors 2004 themselves (for example, L1 and L2 cache), while other memory/storage 2012 is external to the processors 2004 but accessible thereto via a memory interface. The memory/storage 2012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2008 may include transceiver circuitry and a radio frequency front module (RFEM) that allows the UE 2000 to communicate with other devices over a radio access network. The RF interface circuitry 2008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 2024 and proceed to filter and amplify (with a low-noise amplifier) the signal. The signal may be provided to a receiver of the transceiver that down-converts the RF signal into a baseband signal that is provided to the baseband processor of the processors 2004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 2024.

In various embodiments, the RF interface circuitry 2008 may be configured to transmit/receive signals in a manner compatible with NR access technologies.

The antenna 2024 may include a number of antenna elements that each convert electrical signals into radio waves to travel through the air and to convert received radio waves into electrical signals. The antenna elements may be arranged into one or more antenna panels. The antenna 2024 may have antenna panels that are omnidirectional, directional, or a combination thereof to enable beamforming and multiple input, multiple output communications. The antenna 2024 may include microstrip antennas, printed antennas fabricated on the surface of one or more printed circuit boards, patch antennas, phased array antennas, etc. The antenna 2024 may have one or more panels designed for specific frequency bands including bands in FR1 or FR2.

The user interface circuitry 2016 includes various input/output (I/O) devices designed to enable user interaction with the UE 2000. The user interface 2016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 2000.

The sensors 2020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2022 may include software and hardware elements that operate to control particular devices that are embedded in the UE 2000, attached to the UE 2000, or otherwise communicatively coupled with the UE 2000. The driver circuitry 2022 may include individual drivers allowing other components to interact with or control various input/output (I/O) devices that may be present within, or connected to, the UE 2000. For example, driver circuitry 2022 may include a display driver to control and allow access to a display device, a touchscreen driver to control and allow access to a touchscreen interface, sensor drivers to obtain sensor readings of sensor circuitry 2020 and control and allow access to sensor circuitry 2020, drivers to obtain actuator positions of electro-mechanic components or control and allow access to the electro-mechanic components, a camera driver to control and allow access to an embedded image capture device, audio drivers to control and allow access to one or more audio devices.

The PMIC 2024 may manage power provided to various components of the UE 2000. In particular, with respect to the processors 2004, the PMIC 2024 may control power-source selection, voltage scaling, battery charging, or DC-to-DC conversion.

In some embodiments, the PMIC 2024 may control, or otherwise be part of, various power saving mechanisms of the UE 2000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2000 may power down for brief intervals of time and thus save power. If there is no data traffic activity for an extended period of time, then the UE 2000 may transition off to an RRC Idle state, where it disconnects from the network and does not perform operations such as channel quality feedback, handover, etc. The UE 2000 goes into a very low power state and it performs paging where again it periodically wakes up to listen to the network and then powers down again. The UE 2000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2028 may power the UE 2000, although in some examples the UE 2000 may be mounted deployed in a fixed location, and may have a power supply coupled to an electrical grid. The battery 2028 may be a lithium ion battery, a metal-air battery, such as a zinc-air battery, an aluminum-air battery, a lithium-air battery, and the like. In some implementations, such as in vehicle-based applications, the battery 2028 may be a typical lead-acid automotive battery.

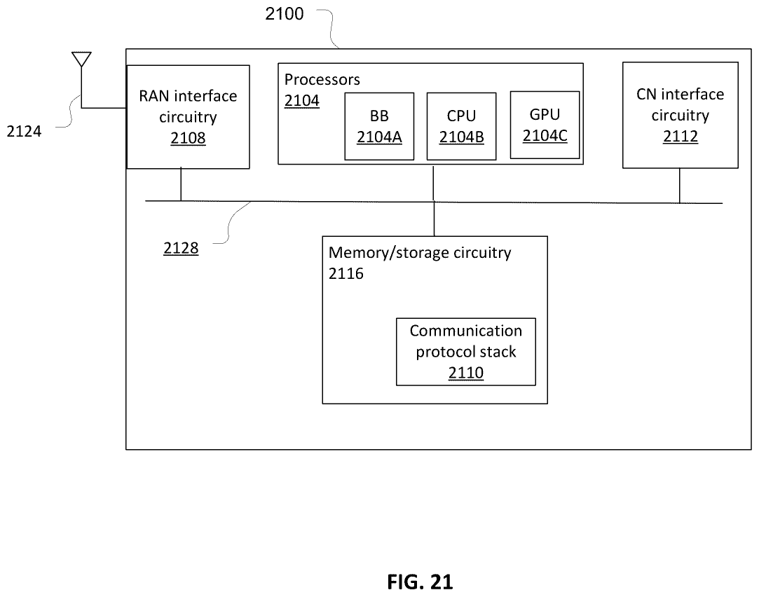

FIG. 21 illustrates a gNB 2100, in accordance with some embodiments.

The gNB 2100 may include processors 2104, RF interface circuitry 2108, core network (CN) interface circuitry 2112, and memory/storage circuitry 2116.

The components of the gNB 2100 may be coupled with various other components over one or more interconnects 2128.

The processors 2104, RF interface circuitry 2108, memory/storage circuitry 2116 (including communication protocol stack 2110), antenna 2124, and interconnects 2128 may be similar to like-named elements shown and described with respect to FIG. 19.

The CN interface circuitry 2112 may provide connectivity to a core network, for example, a 4th Generation Core network (5GC) using a 4GC-compatible network interface protocol such as carrier Ethernet protocols, or some other suitable protocol. Network connectivity may be provided to/from the gNB 2100 via a fiber optic or wireless backhaul. The CN interface circuitry 2112 may include one or more dedicated processors or FPGAs to communicate using one or more of the aforementioned protocols. In some implementations, the CN interface circuitry 2112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided

Example 1 includes a user equipment (UE), comprising a processor; a first antenna panel; a second antenna panel; and a computer-readable medium including instructions that, when executed by the processor, cause the processor to perform operations comprising: receiving a first indication as to a multi-panel simultaneous transmission scheme for simultaneous physical uplink control channel (PUCCH) transmissions in a frequency domain (FD), the simultaneous PUCCH transmissions including a first PUCCH transmission through the first antenna panel of the UE over a first FD part and a second PUCCH transmission through the second antenna panel of the UE over a second FD part; transmitting, to a first transmit and receive point (TRP), the first PUCCH transmission through first antenna panel over the first FD part according to the multi-panel simultaneous transmission scheme; and transmitting, to a second TRP, the second PUCCH transmission through the second antenna panel over the second FD part according to the multi-panel simultaneous transmission scheme, the second PUCCH transmission being transmitted simultaneously with the first PUCCH transmission.

Example 2 includes the UE of example 1, wherein the multi-panel simultaneous transmission scheme includes at least one of: a first frequency division multiplexing scheme, in which the first PUCCH transmission includes a portion of a PUCCH transmission and the second PUCCH transmission includes a remaining portion of the PUCCH transmission; a second frequency multiplexing scheme, in which the first PUCCH transmission includes the PUCCH transmission and the second PUCCH transmission includes a repetition of the PUCCH transmission; or a single frequency network (SFN) scheme, in which the first PUCCH transmission is transmitted via a first PUCCH resource and the second PUCCH transmission is transmitted via a second PUCCH resource, wherein the first PUCCH resource overlaps in either a time domain or the frequency domain with the second PUCCH resource.

Example 3 includes the UE of example 1, wherein the first indication is received via a radio resource control (RRC) transmission, and wherein the instructions, when executed by the processor, further cause the processor to perform the operations including performing the indicated multi-panel simultaneous transmission scheme in response to receiving the first indication via the RRC transmission.

Example 4 includes the UE of example 1, wherein the first indication is received via a radio resource control (RRC) transmission, and wherein the instructions, when executed by the processor, further cause the processor to perform the operations including: receiving a second indication via downlink control information (DCI), including a confirmation of the multi-panel simultaneous transmission scheme; and performing the indicated multi-panel simultaneous transmission scheme in response to receiving the confirmation.

Example 5 includes the UE of example 1, wherein the first indication is based on an RRC PUCCH resource configuration, and wherein the RRC PUCCH resourcing configuration includes a tag on a PUCCH resource indicating the multi-panel simultaneous transmission scheme.

Example 6 includes the UE of example 1, wherein the instructions, when executed by the processor, further cause the processor to perform the operations including receiving a second indication including an identification of a PUCCH resource to be used to transmit the PUCCH transmission, the second indication further including a PUCCH format, a first starting physical resource block (PRB) of the first PUCCH transmission, a second starting PRB of the second PUCCH transmission, a first number of PRBs of the first FD part, and a second number of PRBs of the second FD part.

Example 7 includes the UE of example 1, wherein the instructions, when executed by the processor, further cause the processor to perform the operations including: dividing a PUCCH resource into a first set of resource blocks associated with the first PUCCH transmission and a second set of resource blocks associated with the second PUCCH transmission, where a total number of resource blocks is based on a PUCCH format of the PUCCH transmission.

Example 8 includes the UE of example 1, wherein the instructions, when executed by the processor, further cause the processor to perform the operation including: dividing a sequence of uplink control information (UCI) bits into a first set of UCI bits associated with the first PUCCH transmission and a second set of UCI bits associated with the second PUCCH transmission; encoding the first set of UCI bits to generate a first set of encoded symbols; encoding the second set of UCI bits to generate a second set of encoded symbols; transmitting the first set of encoded symbols in the first PUCCH transmission; and transmitting the second set of encoded symbols in the second PUCCH transmission.

Example 9 includes the UE of example 1, wherein the instructions, when executed by the processor, further cause the processor to perform operation including: encoding a sequence of UCI bits to generate a set of encoded symbols; dividing the set of encoded symbols into a first set of encoded symbols associated with the first PUCCH transmission and a second set of encoded symbols associated with the second PUCCH transmission; transmitting the first set of encoded symbols in the first PUCCH transmission; and transmitting the second set of encoded symbols in the second PUCCH transmission.

Example 10 includes the UE of example 1, wherein the instructions, when executed by the processor, further cause the processor to perform operation including: receiving a parameter associated with the first PUCCH transmission, wherein the parameter is independents of the second PUCCH transmission, and where in the parameter includes one of: an initial cyclic shift parameter, wherein the initial cyclic shift parameter is based on a PUCCH format; an orthogonal cover code (OCC) parameter, the OCC parameter being based on a PUCCH format; a number of symbols parameter; and a starting symbol index parameter.

Example 11 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a balance of the PUCCH transmission; and wherein the instructions, when executed by the processor, further cause the processor to perform operations including prioritizing the first PUCCH resource over the second PUCCH resource for a multiplexing procedure.

Example 12 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a balance of the PUCCH transmission; and wherein the instructions, when executed by the processor, further cause the processor to perform operations including determining whether to prioritize the first PUCCH resource over the second PUCCH resource for a multiplexing procedure based on a rules based configuration, wherein the first PUCCH resource is divided into a first set of resource blocks associated with the first PUCCH transmission and a second set of resource blocks associated with a second PUCCH transmission.

Example 13 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a balance of the PUCCH transmission; and wherein the instructions, when executed by the processor, further cause the processor to perform operations including determining whether to prioritize the first PUCCH resource over the second PUCCH resource for a multiplexing procedure based on a rules based configuration, wherein the first PUCCH resource is divided into a first set of resource blocks associated with the first PUCCH transmission and a second set of resource blocks associated with a second PUCCH transmission.

Example 14 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a balance of the PUCCH transmission; and wherein the instructions, when executed by the processor, further cause the processor to perform operations including determining whether to prioritize the first PUCCH resource over the second PUCCH resource for a multiplexing procedure based on a rules based configuration, wherein a sequence of uplink control information (UCI) bits is divided into a first set of UCI bits associated with the first PUCCH transmission and a second set of UCI bits associated with the second PUCCH transmission, the first set of UCI bits being encoded to generate a first set of encoded symbols, the second set of UCI bits being encoded to generate a second set of encoded symbols, the first set of encoded symbols being transmitted in the first PUCCH transmission, and the second set of encoded symbols being transmitted in the second PUCCH transmission.

Example 15 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a balance of the PUCCH transmission; and wherein the instructions, when executed by the processor, further cause the processor to perform operation including prioritizing a portion of Uplink Control Information (UCI) associated with the second PUCCH resource, wherein the second PUCCH resource is not associated with repetitions.

Example 16 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including determining, respectively per the first antenna panel and the second antenna panel, whether to drop the first PUCCH resource or the second PUCCH resource based on a priority of UCI associated with the second PUCCH resource.

Example 17 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including prioritizing the first PUCCH resource over the second PUCCH resource for a multiplexing procedure.

Example 18 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a single panel third PUCCH transmission using the first antenna panel, wherein the multi-panel simultaneous transmission scheme includes an SFN scheme, in which the first PUCCH transmission is transmitted via a first PUCCH resource and the second PUCCH transmission is transmitted via a third PUCCH resource, wherein the first PUCCH resource overlaps in a time domain the third PUCCH resource; and wherein the instructions, when executed by the processor, further cause the processor to perform operations including prioritizing the first PUCCH resource over the second PUCCH resource for a multiplexing procedure.

Example 19 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a multi panel third PUCCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a remaining portion of the PUCCH transmission; wherein the first PUCCH resource overlaps in a time domain with the third PUCCH resource; and wherein the instructions, when executed by the processor, further cause the processor to perform operations including determining whether to prioritize the first PUCCH resource over the second PUCCH resource based on a rules based configuration.

Example 20 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a multi panel third PUCCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; wherein the first PUCCH resource overlaps in a time domain with the third PUCCH resource; and wherein the instructions, when executed by the processor, further cause the processor to perform operations including determining whether to prioritize the first PUCCH resource over the second PUCCH resource by considering both the first PUCCH resource and the second PUCCH resource to be with repetitions.

Example 21 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a multi panel third PUCCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; wherein the first PUCCH resource overlaps in a time domain with the third PUCCH resource; and wherein the instructions, when executed by the processor, further cause the processor to perform operations including determining whether to prioritize the first PUCCH resource over the second PUCCH resource by assuming, per panel, the first PUCCH resource overlapping the second PUCCH resource without repetitions.

Example 22 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a second PUCCH resource in a time domain, wherein the second PUCCH resource is associated with a multi panel third PUCCH transmission using the first antenna panel, wherein the multi-panel simultaneous transmission scheme includes an SFN scheme, in which the first PUCCH transmission is transmitted via a first PUCCH resource and the second PUCCH transmission is transmitted via a third PUCCH resource, wherein the first PUCCH resource overlaps in a time domain the third PUCCH resource; and wherein the instructions, when executed by the processor, further cause the processor to perform operations including determining whether to prioritize the first PUCCH resource over the second PUCCH resource by assuming, per panel, the first PUCCH resource overlapping the second PUCCH resource without repetitions.

Example 23 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a remaining portion of the PUCCH transmission; and wherein the instructions, when executed by the processor, further cause the processor to perform operations including: multiplexing UCI on the first PUSCH transmission; and transmitting the first PUSCH transmission using the first antenna panel, wherein the first PUSCH transmission is associated with the first antenna panel.

Example 24 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a remaining portion of the PUCCH transmission; and wherein the instructions, when executed by the processor, further cause the processor to perform operations including: multiplexing UCI on first antenna panel, wherein the first antenna panel is associated with the first PUSCH transmission; transmitting the first PUSCH transmission using the first antenna panel; and transmitting the first PUCCH wherein the first PUSCH transmission is associated with the first antenna panel.

Example 25 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes a first frequency division multiplexing scheme, in which the first PUCCH transmission includes a portion of a PUCCH transmission and the second PUCCH transmission includes a remaining portion of the PUCCH transmission; and wherein the instructions, when executed by the processor, further cause the processor to perform operations including dropping the first PUSCH transmission.

Example 26 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including determining a multiplexing procedure based on a rules based configuration and considering the first PUCCH resource to be with repetitions.

Example 27 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including determining a multiplexing procedure based on a, per panel, rules based configuration and considering the first PUCCH resource to be without repetitions.

Example 28 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with a first PUSCH resource in a time domain, wherein the first PUSCH resource is associated with a single panel first PUSCH transmission using the first antenna panel, wherein the multi-panel simultaneous transmission scheme includes an SFN scheme, in which the first PUCCH transmission is transmitted via a first PUCCH resource and the second PUCCH transmission is transmitted via a third PUCCH resource, wherein the first PUCCH resource overlaps in a time domain the third PUCCH resource; and wherein the instructions, when executed by the processor, further cause the processor to perform operations including determining a multiplexing procedure based on a, per panel, rules based configuration and considering each panel to be without repetitions.

Example 29 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including: multiplexing UCI on each overlapping PUSCH transmission; and transmitting the each PUSCH transmission.

Example 30 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, a first frequency division multiplexing scheme, in which the first PUCCH transmission includes a portion of a PUCCH transmission and the second PUCCH transmission includes a remaining portion of the PUCCH transmission; ; and wherein the instructions, when executed by the processor, further cause the processor to perform operations including: multiplexing UCI on each overlapping PUSCH transmission separately; and transmitting the each PUSCH transmission.

Example 31 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, a first frequency division multiplexing scheme, in which the first PUCCH transmission includes a portion of a PUCCH transmission and the second PUCCH transmission includes a remaining portion of the PUCCH transmission; ; and wherein the instructions, when executed by the processor, further cause the processor to perform operations including: dropping a PUSCH resource based on UCI priority.

Example 32 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, a first frequency division multiplexing scheme, in which the first PUCCH transmission includes a portion of a PUCCH transmission and the second PUCCH transmission includes a remaining portion of the PUCCH transmission; ; and wherein the instructions, when executed by the processor, further cause the processor to perform operations including: dropping a PUSCH resource based on UCI priority.

Example 33 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including determining a multiplexing procedure based on a rules based configuration and considering the first PUCCH resource with repetitions.

Example 11 includes a UE comprising: a processor; a first antenna panel; a second antenna panel; and a computer-readable medium including instructions that, when executed by the processor, cause the processor to perform operations comprising: receiving an indication as to a multi-panel simultaneous transmission scheme for simultaneous physical uplink control channel (PUCCH) transmissions in a frequency domain (FD), the simultaneous PUCCH transmissions a first frequency division multiplexing scheme, in which the first PUCCH transmission using the first antenna panel includes a portion of a PUCCH transmission and a second PUCCH transmission using the second antenna panel includes a balance of the PUCCH transmission, wherein a first PUCCH resource associated with the first PUCCH transmission overlaps with multiple multi panel PUSCH resources in a time domain, wherein the multi-panel simultaneous transmission scheme includes a second frequency multiplexing scheme, in which the first PUCCH transmission includes the PUCCH transmission and the second PUCCH transmission includes a repetition of the PUCCH transmission; and wherein the instructions, when executed by the processor, further cause the processor to perform operations including determining a multiplexing procedure, per panel, based on a rules based configuration and considering the first PUCCH resource without repetitions, wherein each PUCCH repetition is multiplexed a corresponding overlapping PUSCH transmission.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A user equipment (UE), comprising:
a processor;
a first antenna panel;
a second antenna panel; and
a computer-readable medium including instructions that, when executed by the processor, cause the processor to perform operations comprising:
receiving a first indication as to a multi-panel simultaneous transmission scheme for simultaneous physical uplink control channel (PUCCH) transmissions in a frequency domain (FD), the simultaneous PUCCH transmissions including a first PUCCH transmission through the first antenna panel of the UE over a first FD part and a second PUCCH transmission through the second antenna panel of the UE over a second FD part;
transmitting, to a first transmit and receive point (TRP), the first PUCCH transmission through first antenna panel over the first FD part according to the multi-panel simultaneous transmission scheme; and
transmitting, to a second TRP, the second PUCCH transmission through the second antenna panel over the second FD part according to the multi-panel simultaneous transmission scheme, the second PUCCH transmission being transmitted simultaneously with the first PUCCH transmission.

2. The UE of claim 1, wherein the operations further comprise: receiving the first indication in a radio resource control (RRC) PUCCH configuration, wherein the multi-panel simultaneous transmission scheme is a single frequency network (SFN) scheme in which the first PUCCH transmission is transmitted via a first PUCCH resource and the second PUCCH transmission is transmitted via a second PUCCH resource.

3. The UE of claim 1, wherein the first indication is received via a radio resource control (RRC) transmission, and wherein the operations further comprise:
performing the indicated multi-panel simultaneous transmission scheme in response to receiving the first indication via the RRC transmission.

4. The UE of claim 1, wherein the first indication is received via a radio resource control (RRC) transmission, and wherein the operations further comprise:
receiving a second indication via downlink control information (DCI), including a confirmation of the multi-panel simultaneous transmission scheme; and
performing the indicated multi-panel simultaneous transmission scheme in response to receiving the confirmation.

5. The UE of claim 1, wherein the first indication is based on a radio resource control (RRC) PUCCH resource configuration, and wherein the RRC PUCCH resource configuration includes a tag on a PUCCH resource to indicate the multi-panel simultaneous transmission scheme.

6. The UE of claim 1, wherein the operations further comprise:
receiving a second indication including an identification of a PUCCH resource to be used to transmit the PUCCH transmission, the second indication further including a PUCCH format, a first starting physical resource block (PRB) of the first PUCCH transmission, a second starting PRB of the second PUCCH transmission, a first number of PRBs of the first FD part, and a second number of PRBs of the second FD part.

7. The UE of claim 1, wherein the operations further comprise:
dividing a PUCCH resource into a first set of resource blocks associated with the first PUCCH transmission and a second set of resource blocks associated with the second PUCCH transmission, where a total number of resource blocks is based on a PUCCH format of the PUCCH transmission.

8. The UE of claim 1, wherein the operations further comprise:
dividing a sequence of uplink control information (UCI) bits into a first set of UCI bits associated with the first PUCCH transmission and a second set of UCI bits associated with the second PUCCH transmission;
encoding the first set of UCI bits to generate a first set of encoded symbols;
encoding the second set of UCI bits to generate a second set of encoded symbols;
transmitting the first set of encoded symbols in the first PUCCH transmission; and
transmitting the second set of encoded symbols in the second PUCCH transmission.

9. The UE of claim 1, wherein the operations further comprise:
encoding a sequence of UCI bits to generate a set of encoded symbols;
dividing the set of encoded symbols into a first set of encoded symbols associated with the first PUCCH transmission and a second set of encoded symbols associated with the second PUCCH transmission;
transmitting the first set of encoded symbols in the first PUCCH transmission; and
transmitting the second set of encoded symbols in the second PUCCH transmission.

10. The UE of claim 1, wherein the operations further comprise:
receiving a parameter associated with the first PUCCH transmission, wherein the parameter is independents of the second PUCCH transmission, and where in the parameter includes one of:
an initial cyclic shift parameter, wherein the initial cyclic shift parameter is based on a PUCCH format;
an orthogonal cover code (OCC) parameter, the OCC parameter being based on a PUCCH format;
a number of symbols parameter; and
a starting symbol index parameter.

11. A non-transitory, computer-readable medium having stored thereon a sequence of instructions which, when executed, causes a processor to perform operations comprising:
receiving a first indication as to a multi-panel simultaneous transmission scheme for simultaneous physical uplink control channel (PUCCH) transmissions in a frequency domain (FD), the simultaneous PUCCH transmissions including a first PUCCH transmission through a first antenna panel of the UE over a first FD part and a second PUCCH transmission through a second antenna panel of the UE over a second FD part;
transmitting, to a first transmit and receive point (TRP), the first PUCCH transmission through first antenna panel over the first FD part according to the multi-panel simultaneous transmission scheme; and
transmitting, to a second TRP, the second PUCCH transmission through the second antenna panel over the second FD part according to the multi-panel simultaneous transmission scheme, the second PUCCH transmission being transmitted simultaneously with the first PUCCH transmission.

12. The non-transitory, computer-readable medium of claim 11, wherein the operations further comprise:
receiving the first indication in a radio resource control (RRC) PUCCH configuration, wherein the multi-panel simultaneous transmission scheme is a single frequency network (SFN) scheme in which the first PUCCH transmission is transmitted via a first PUCCH resource and the second PUCCH transmission is transmitted via a second PUCCH resource.

13. The non-transitory, computer-readable medium of claim 11, wherein the first indication is received via a radio resource control (RRC) transmission, and wherein the operations further comprise:
performing the indicated multi-panel simultaneous transmission scheme in response to receiving the first indication via the RRC transmission.

14. The non-transitory, computer-readable medium of claim 11, wherein the first indication is based on a radio resource control (RRC) PUCCH resource configuration, and wherein the RRC PUCCH resourcing configuration includes a tag on a PUCCH resource indicating the multi-panel simultaneous transmission scheme.

15. The non-transitory, computer-readable medium of claim 11, wherein the first indication is based on an RRC PUCCH resource configuration, and wherein the RRC PUCCH resourcing configuration includes a tag on a PUCCH resource indicating the multi-panel simultaneous transmission scheme.

16. The non-transitory, computer-readable medium of claim 11, wherein the operations further comprise:
receiving a second indication including an identification of a PUCCH resource to be used to transmit the PUCCH transmission, the second indication further including a PUCCH format, a first starting physical resource block (PRB) of the first PUCCH transmission, a second starting PRB of the second PUCCH transmission, a first number of PRBs of the first FD part, and a second number of PRBs of the second FD part.

17. The non-transitory, computer-readable medium of claim 11, wherein the operations further comprise:
dividing a PUCCH resource into a first set of resource blocks associated with the first PUCCH transmission and a second set of resource blocks associated with the second PUCCH transmission, where a total number of resource blocks is based on a PUCCH format of the PUCCH transmission.

18. The non-transitory, computer-readable medium of claim 11, wherein the operations further comprise:
dividing a sequence of uplink control information (UCI) bits into a first set of UCI bits associated with the first PUCCH transmission and a second set of UCI bits associated with the second PUCCH transmission;
encoding the first set of UCI bits to generate a first set of encoded symbols;
encoding the second set of UCI bits to generate a second set of encoded symbols;
transmitting the first set of encoded symbols in the first PUCCH transmission; and
transmitting the second set of encoded symbols in the second PUCCH transmission.

19. A network node, comprising:
a processor; and
a computer-readable medium including instructions that, when executed by the processor, cause the processor to perform operations including:
transmitting, via downlink control information (DCI) and to a user equipment (UE) an indication of a single frequency network (SFN) scheme for simultaneous transmission of a physical uplink control channel (PUCCH) transmission in a frequency domain (FD);
receiving, at a first transmit and receive point (TRP) of the network, a first PUCCH transmission from the UE based on the SFN scheme; and
receiving, at a second TRP of the network, a second PUCCH transmission from the UE based on the SFN scheme.

20. The network node of claim 19, wherein the operations further comprise;
configuring a PUCCH resource for an SFN scheme.
